(19) United States
(12) Patent Application Publication
(10) Pub. No.: US 2015/0352743 A1
(43) Pub. Date: Dec. 10, 2015

(54) COMBINATION CANTING AND PROFILING APPARATUS

(71) Applicant: WaneShear Technologies LLC, Ukiah, CA (US)

(72) Inventor: Ronald W. McGehee, Point Roberts, WA (US)

(73) Assignee: WANESHEAR TECHNOLOGIES LLC, Ukiah, CA (US)

(21) Appl. No.: 14/730,067

(22) Filed: Jun. 3, 2015

Related U.S. Application Data
(60) Provisional application No. 62/009,053, filed on Jun. 6, 2014.

(51) Int. Cl. B27C 1/08; B27C 5/00

(52) U.S. Cl. CPC B27C 1/08; B27C 5/00

(57) ABSTRACT

A combination canting and profiling apparatus includes a cutter assembly, including a profiler and a canter, supported by a support frame for movement in unison with the support frame. The profiler and the canter each have first and second cutter heads respectively rotatable about first and second axes and positioned at work piece profiling and canting stations along a workpiece feed path next to one another without any workpiece drivers therebetween. The profiler and the canter can be mounted to the support frame for movement relative to one another along a lateral positioning path oriented generally perpendicular to the workpiece feed path. Structure can also be included to facilitate curve sawing. In some examples motors driving the cutters can be arranged for load sharing.

### CROSS-REFERENCE TO OTHER APPLICATIONS

This application claims the benefit of U.S. provisional patent application No. 62/009,053 filed 6 Jun. 2014.

### BACKGROUND OF THE INVENTION

This invention is for an improved method and apparatus for milling timber in a lumber mill.

FIGS. 1 and 2 illustrate one common way of how a log is transformed into lumber. In this example gang saws can be used to make parallel cuts 10 along the length of log 12 to create the cant 14 having flat, parallel upper and lower surfaces 16, 18, waste wane pieces 20 and unfinished boards 22. The rough edges of the unfinished boards are trimmed at trim lines 23 to create the finished boards. Cant 14 is then processed by a canter 24 and a profiler 26. The canter/profiler assembly shown in FIG. 2 has feed modules 27 for supporting and driving the cant 14 through both canter 24 and profiler 26. Feed modules commonly include upper and lower rollers which support and drive the workpiece through the canter and profiler. Canter 24 and profiler 26 commonly use milling cutting heads to chip away the material at canter regions 28 and profiler regions 30 on either side of cant 14. This creates a processed workpiece 32 having side faces 34 created by canter 24 and side board profiles 36 created by profiler 26. As indicated in FIG. 1, processed workpiece 32 can be cut into lumber at a downstream gang saw station. In some cases instead of a cant 14, a log 12 with no finished faces is processed by the canter and the profiler.

Canting and profiling a log or cant with today's machinery commonly uses a large diameter (typically 30 plus inches in diameter) milling tool for the canting tools and large diameter (typically 15 inch to 22 inch diameter) profiling tools. FIG. 2 illustrates a typical arrangement for canting and profiling a log or cant, sometimes referred to as the workpiece. The large diameter tools commonly used prevent the close nesting of the milling tools and require feed modules between the canter and profiler. The length 38 of a typical canter/profiler today, measured from the beginning of the canter to the end of the profiler in the example of FIG. 2, is at least 90 inches long and some are as much as 120 inches long. The length of the existing canter/profilers limit the number of sawmills that can fit one into place adjacent to existing saws and increases cost due to the necessary additional space and feeding equipment.

### BRIEF SUMMARY OF THE INVENTION

The present technology can reduce the space requirement for the machinery by a factor of up to four. In some examples the distance from the beginning of the canter to the end of the profiler is less than 30 inches. The present technology addresses the space issue by tightly nesting the cutting tools and using a unique drive system. This can make the installation and operation of the equipment more cost effective and efficient for the end user. In addition, the present technology is very accurate due to the close proximity of the canter and profiler cutter heads. This close spacing eliminates any transport error between the canter and the profiler and also eliminates errors caused by the stress relieving of the cant as the sides are chipped off. The fact that all the cutting tools are mounted on the same support frame, in examples the support frame being subject to lateral shifting, vertical shifting and pivoting about a common vertical axis, greatly enhances the accuracy of the process by eliminating following errors between the canter and profiler systems. In a conventional system, the canter and profiler cutter heads can be separated by as much as 8 feet and will commonly have their own lateral shifting, vertical lifting and pivoting about a pivot axis that are independent and subject to large following errors in the motion control systems.

Some examples are directed to a log or cant milling machine that opens the face of the cant or log with twin counter rotating milling tools and immediately mills a profile of the side board on the side of the cant or log with twin counter rotating and adjustable milling tools. The milling tools used are smaller in diameter than any existing milling tools currently used in the industry for canting and profiling log or cants. The milling tools can be driven to a gearbox with a combination of spiral bevel and helical gears. The small diameter (typically 10″ to 12″) milling heads and the unique drive arrangement of spiral bevel and helical gears allows the canter/profiler to be incorporated into a very small space both length wise (along the workpiece feed path) and width wise (perpendicular to the workpiece feed path). This very short length also improves the accuracy of the profile cuts on the log or cant. In conventional canter/profilers, the canter is mounted several feet in front of the profiler allowing for the log or cant to move out of position or deflect due to stress relieving and warping of the log or cant due to the material removal by the canter milling tools. With the present technology the workpieces never passed off between the canter and the profiler stations thus eliminating cutting inaccuracies present with conventional canter/profilers.

A combination canting and profiling apparatus includes a cutter assembly supported by a support frame for movement in unison with the support frame. The cutter assembly includes profiler and a canter. The profiler comprises first and second, spaced apart, profiler cutter heads mounted for rotation about first and second profiler axes and positioned at a work piece profiling station along a workpiece feed path. The canter comprises a canter cutter head mounted for rotation about a canter axis and positioned at a work piece canting station along the workpiece feed path. The work piece profiling station and the work piece canting station are next to one another.

The combination canting and profiling apparatus can include one or more the following. The first and second profiler axes can be parallel to one another and can be parallel to the canter axis. The canter can include first and second canter cutter heads mounted for rotation about first and second canter axes. The profiler and the canter can be mounted to the support frame for movement relative to one another along a lateral positioning path oriented generally perpendicular to the workpiece feed path. The distance between the centers of the profiler and the canter can be no more than 24 inches, with the centers defined by the profiler axes and the canter axis. A region between the profiling station and the canting station can be free of any workpiece drivers.

Examples of the combination canting and profiling apparatus can also include a base frame, a carriage, and a profiler cutter heads mounting assembly. The carriage can support the support frame, and the cutter assembly therewith, on the base frame. The carriage can include a lateral slide assembly and a vertical lift assembly. The lateral slide assembly is slideably mounted to the base frame by which a position of the support frame in a lateral direction generally perpendicular to the workpiece feed path can be changed during use. The vertical lift assembly is movably mounted to the lateral slide assembly by which a vertical position of the support frame can be changed during use. The profiler cutter heads mounting assembly can mount the first and second profiler cutter heads to the support frame at different separations so that a distance between the first and second profiler cutter heads can be changed during use. In some examples the profiler cutter heads mounting assembly changes the distance between the first and second profiler cutter heads in equal amounts relative to the workpiece feed path. To facilitate curve sawing, the carriage can further include a main pivot housing, mounted to a chosen one of the lateral slide assembly and the vertical lift assembly, rotationally supporting the support frame by which a rotary orientation of the support frame about a first axis can be changed, the first axis being spaced apart from and generally perpendicular to the workpiece feed path. The cutter assembly can include a pivot housing by which a rotary orientation of a chosen one of the profiler and the canter about a second axis can be changed relative to the other of the profiler and the canter, the second axis being parallel to the first axis.

In some examples the canter can include first and second canter cutter heads mounted for rotation about first and second canter axes and the motor assembly can include driveshafts with the profiler cutter heads and the canter cutter heads drivenly coupled to driveshafts of the motor assembly. The motor assembly can include a ganged motor assembly comprising at least three motors with driveshafts drivingly and drivenly coupled to one another to provide load sharing among the motors. The canter can include first and second canter cutter heads mounted for rotation about first and second canter axes and the motor assembly can include first, second, third and fourth motors. The first and second profiler cutter heads can be connected to driveshafts of the first and second motors. The first and second canter cutter heads can be connected to driveshafts of the third and fourth motors. The third and fourth motors can be drivingly and drivenly coupled to one another to facilitate load sharing. The ganged motor assembly can include fifth and sixth motors, the third, fourth, fifth and sixth motors directly coupled to one another by gears mounted to driveshafts of said motors, whereby the driveshafts of the fifth and sixth motors aid the rotation of the driveshafts of the third and fourth motors thereby facilitating load sharing.

Other features, aspects and advantages of the present invention can be seen on review the drawings, the detailed description, and the claims which follow.

### BRIEF DESCRIPTION OF THE DRAWINGS

FIG. 1 schematically illustrates a series of steps by which a log can be transformed into lumber.

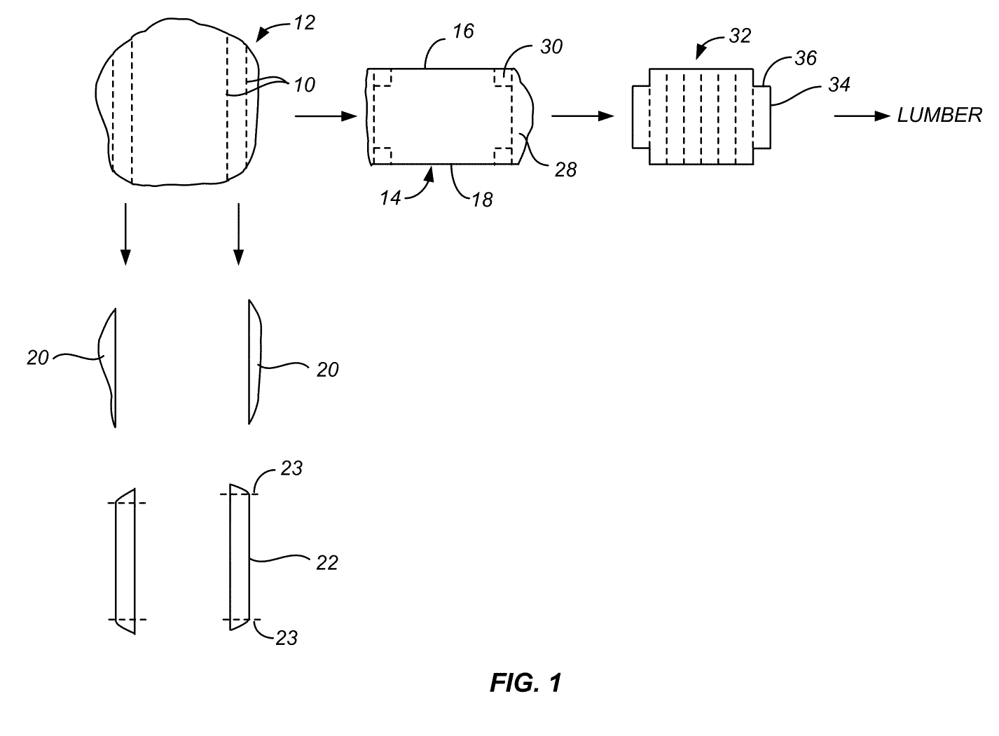

FIG. 2 is a schematic illustration showing feed modules on either side of and between canter and profiler stations of a conventional canter/profiler system.

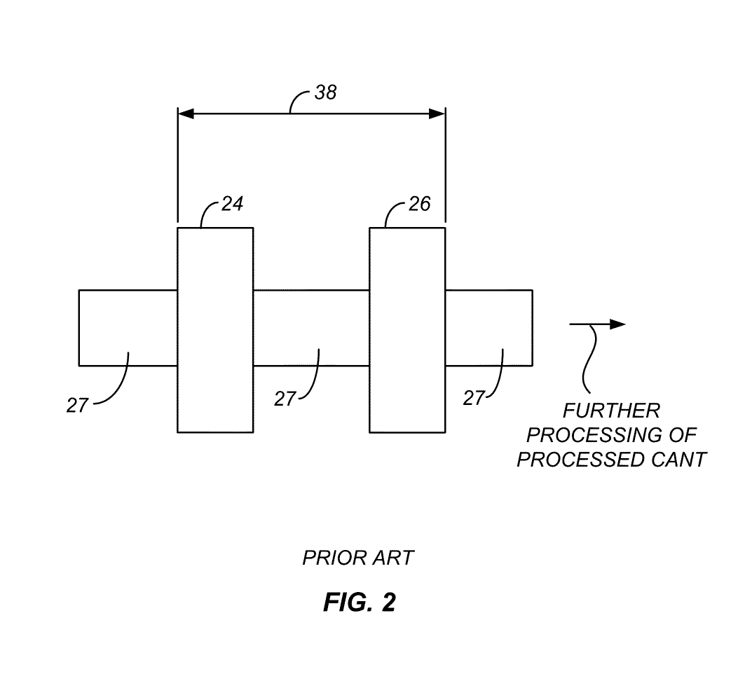

FIG. 3 is a perspective view of a combination canting and profiling apparatus shown together with a partially processed cant.

FIG. 3A is a perspective view showing the partially processed cant of FIG. 3.

FIG. 4 is a second perspective view of the combination canting and profiling apparatus of FIG. 3.

FIG. 5 is a third perspective view of the combination canting and profiling apparatus of FIG. 3.

FIG. 6 is a top plan view showing the profiler and canter of the assembly of FIGS. 3-5 with the profiler and canter axes not rotationally offset and the outer edges of the profiler and canter cutter heads aligned.

FIG. 7 is a view similar to that of FIG. 6 but with the canter and the canter motor assembly moved to the left in FIG. 7 so that the outer edges of the profiler and canter cutter heads are offset.

FIG. 8 shows the structure of FIG. 7 but with the cutter assembly rotationally offset 6° counterclockwise about a vertical axis.

FIG. 9 shows the structure of FIG. 8 after the canter has been rotated clockwise 2° about a vertical axis.

FIG. 10 is a simplified overall view of a second example of a canting and profiling apparatus.

FIGS. 11 and 12 are perspective views of portions of a third example of a canting and profiling apparatus.

### DETAILED DESCRIPTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

In this application the terms horizontal and vertical may be used with reference to referenced items in particular embodiments. However, these terms are used in the aid understanding and not to limit the invention. In some cases the terms perpendicular or parallel may be used; they are intended to cover situations in which the referenced items are perpendicular or parallel within limitations of manufacturing processes and within manufacturing variations. When the terms generally perpendicular or generally parallel are used, these are intended to cover situations in which the referenced items are generally perpendicular or generally parallel within 10°, and preferably within 8°, and more preferably within 6°.

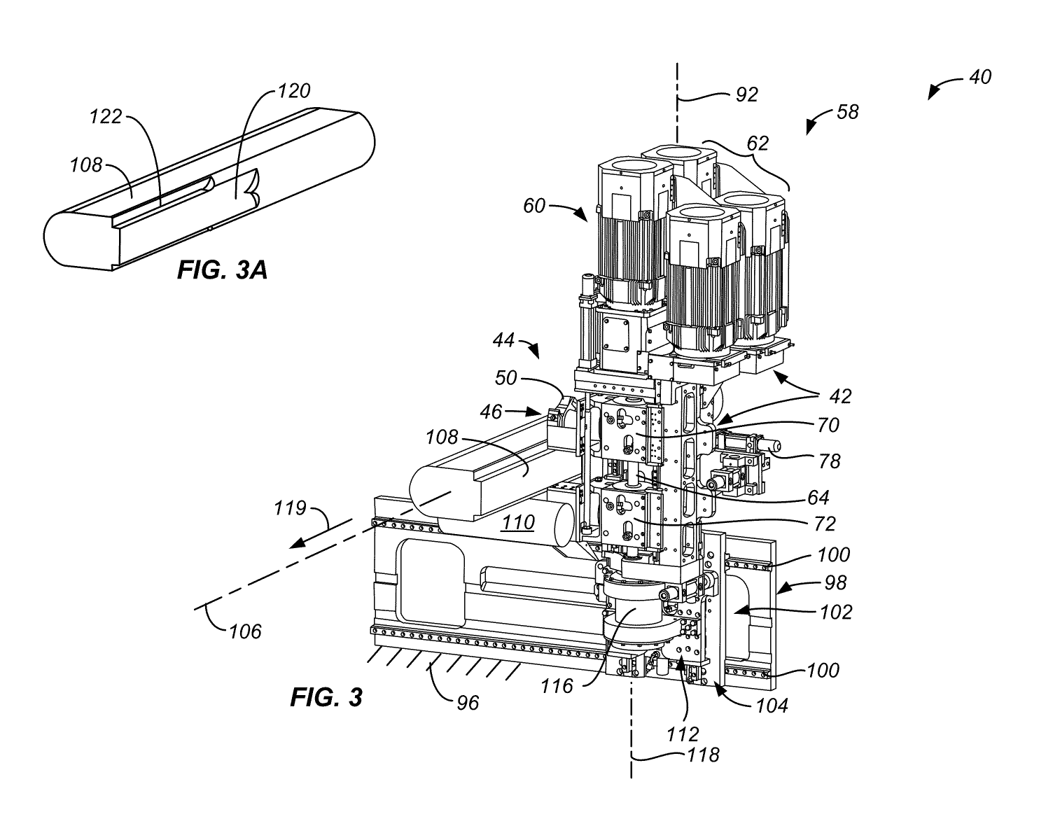

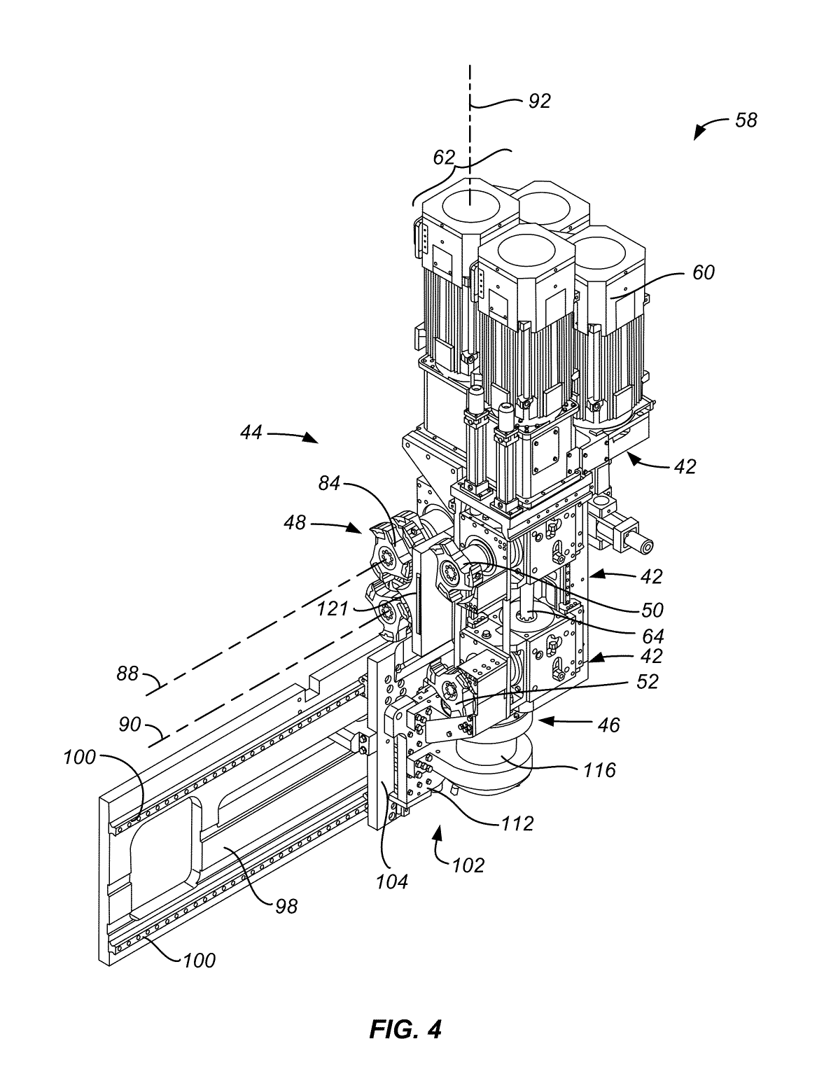

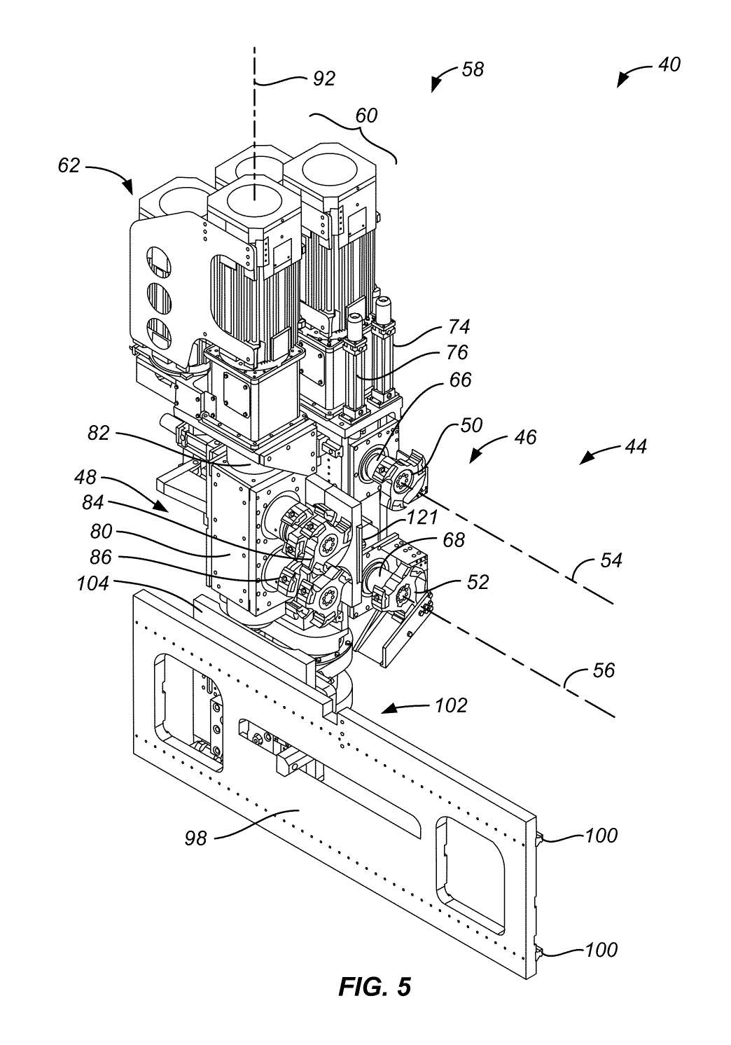

FIGS. 3-5 are overall views of one example of a combination canting and profiling apparatus 40. Apparatus 40 includes a support frame 42 and a cutter assembly 44 mounted to and supported by the support frame for movement in unison with the support frame. Cutter assembly 44 includes a profiler 46 at a workpiece profiling station and a canter 48 at a workpiece canting station. In a sawmill setting, with the exception of lateral side plate 98, the mirror image of the structure shown in FIGS. 3-5 would be duplicated to process both sides of the workpiece.

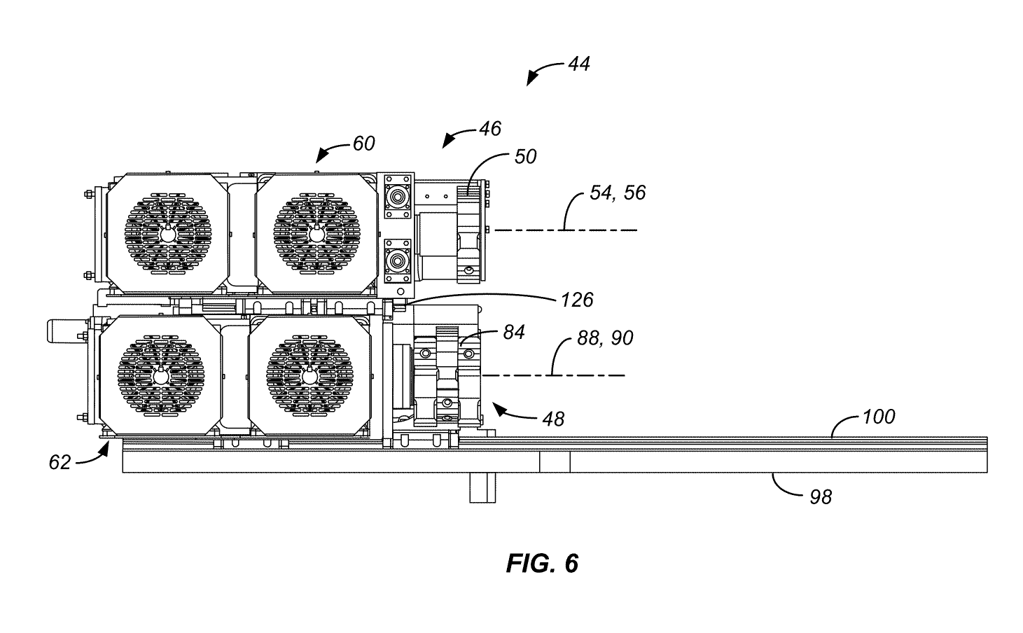

Profiler 46 includes a first, top profiler cutter head 50 and a second, bottom profiler cutter head 52, cutter heads 50, 52 mounted for rotation about first and second profiler axes 54, 56, respectively. Apparatus 40 also includes a motor assembly 58 including a profiler motor assembly 60 and a canter motor assembly 62 both mounted to support frame 42. Each of the profiler motor assembly 60 and the canter motor assembly 62, in this example, includes two electric motors each rated at about 75 to 150 horsepower. The output of the two electric motors constituting profiler motor assembly 60 are, in this example, combined to drive first and second profiler cutter heads 50, 52 through a splined drive shaft 64. The rotational movement of vertically oriented splined drive shaft 64 is transferred to the first and second profiler drive shafts 66, 68, to which first and second profiler cutter heads 50, 52 are mounted, through first and second profiler gearboxes 70, 72. Gearboxes 70, 72 slide along splined drive shaft 64 are supported on a support frame 42 by linear roller bearing assemblies. The vertical separation between gearboxes 70, 72, and thus between first and second profiler cutting heads 50, 52 is changed by linear actuators 74, 76, shown in FIG. 5.

Canter 48 includes a canter gearbox 80 pivotally mounted to support frame 42 by a canter pivot housing 82. Canter 48 includes first and second, overlapping canter cutter heads 84, 86 which are rotated about first and second canter axes 88, 90. As with profiler motor assembly 60, canter motor assembly 62 includes two electric motors each rated about 75 to 150 horsepower so that power from canter motor assembly 62 passes from the motor assembly, through canter gearbox 80 to the horizontal driveshafts which rotate first and second canter cutter heads 84, 86 about first and second canter axes 88, 90. Canter pivot housing 82 is used to rotate gearbox 80 about a canter pivot axis 92 a small amount, such as plus or minus 2°, relative to support frame 42 and thus relative to first and second profiler cutter heads 50, 52. The purpose for this is discussed below.

The distance between the workpiece profiling station and the workpiece canting station is minimal. The horizontal distance between the centers of the workpiece profiling and canting stations, and thus between the centers of profiler 26 and canter 24 as defined by the profiler axes 54, 56 and canter axes 88, 90, is preferably less than 24 inches; in this example the distance between the workpiece profiling and canting stations is 17.5 inches. This can be compared with the center-to-center distance between profiling and canting stations with conventional canter/profilers of about 60 to 96 inches.

In the above example the profiler and canter cutter heads are milling cutter heads; in other examples other types of cutter heads such as disk type cutter heads, could be used. While there will usually be two profiler cutter heads, in appropriate circumstances the two canter cutter heads disclosed could be replaced by a single canter cutter head or more than two canter cutter heads. One or both of profiler axes 54, 56 could be oriented vertically instead of horizontally. If profiler axes 54, 56 are oriented vertically, they can be coaxial. Similarly, the axis for a canter cutter head could be oriented vertically instead of horizontally.

Apparatus 40 also includes a stationary base frame 96, base frame 96 including a lateral side plate 98 having a pair of linear rails 100. Support frame 42 is mounted to and supported by a carriage 102. Carriage 102 includes a lateral/horizontal slide assembly 104 mounted to lateral side plate 98 for movement along the linear rails 100. Such lateral/horizontal movement of carriage 102 causes support frame 42 to move in a similar manner. Such movement of support frame 42 is generally perpendicular to the workpiece feed path 106 shown in FIG. 3 with respect to partially processed cant 108. In FIG. 3 a roller 110 is shown supporting one end of the partially processed cant 108. In practice three upper rollers and three lower rollers can be used on either side of apparatus 40 to support and drive the workpiece through apparatus 40 as is conventional.

Carriage 102 also includes a vertical lift assembly 112 secured to lateral slide assembly 104 for vertical movement along the vertical rails 114 of assembly 112. This movement raises and lowers support frame 42, and cutter assembly 44 and motor assembly 58 therewith, in a vertical direction along a path laterally spaced apart from and perpendicular to the workpiece feed path 106.

Carriage 102 further includes a main pivot housing 116 mounted to vertical lift assembly 112. Support frame 42 is mounted to and supported by main pivot housing 116 which not only provides vertical support for support frame 42 but also permits the support frame and the various components mounted thereto to rotate about a first axis 118. The first axis 118 is farther away from the workpiece feed path 106 than is canter pivot axis 92. First axis 118 is downstream of canter pivot axis 92 relative to the direction of movement 119 of partially processed cant 108.

The location of workpiece feed path 106 changes primarily depending on the size of the workpiece. Typically the lower support rollers 110 are fixed position so that as the size of the workpiece increases, the vertical position of the workpiece feed path 106 is raised. It is desired to keep the counter-rotating canter cutter heads 84, 86 centered on workpiece feed path 106 so that each canter cutter head cuts about the same amount of the workpiece to balance the load and to help ensure an appropriately smooth face 120 is created on the workpiece. Face 120 engages a guide anvil 121, located between the profiler 46 and canter 48, to help position the workpiece as it moves through apparatus 40.

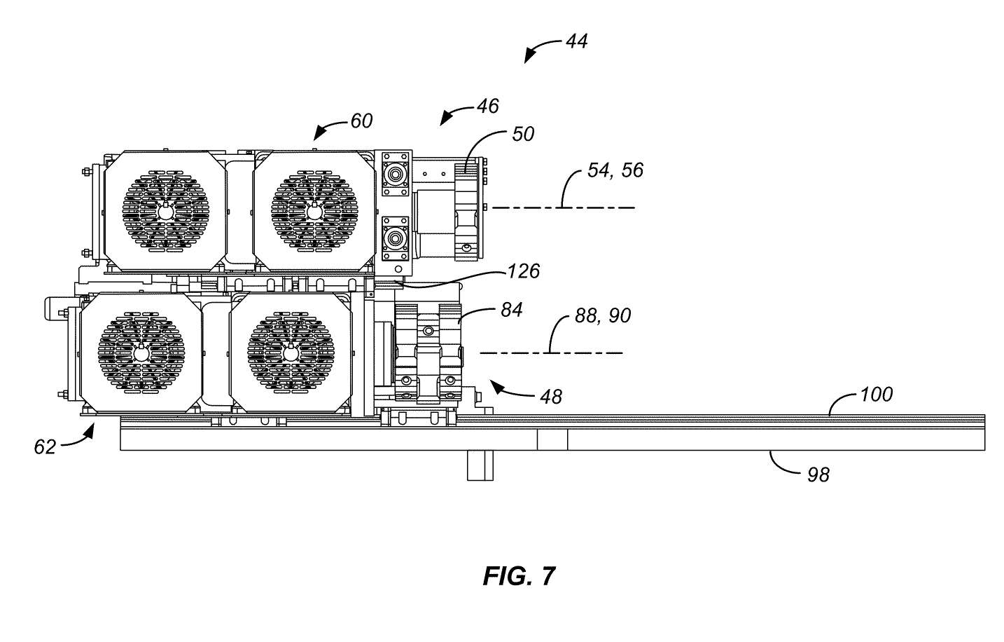

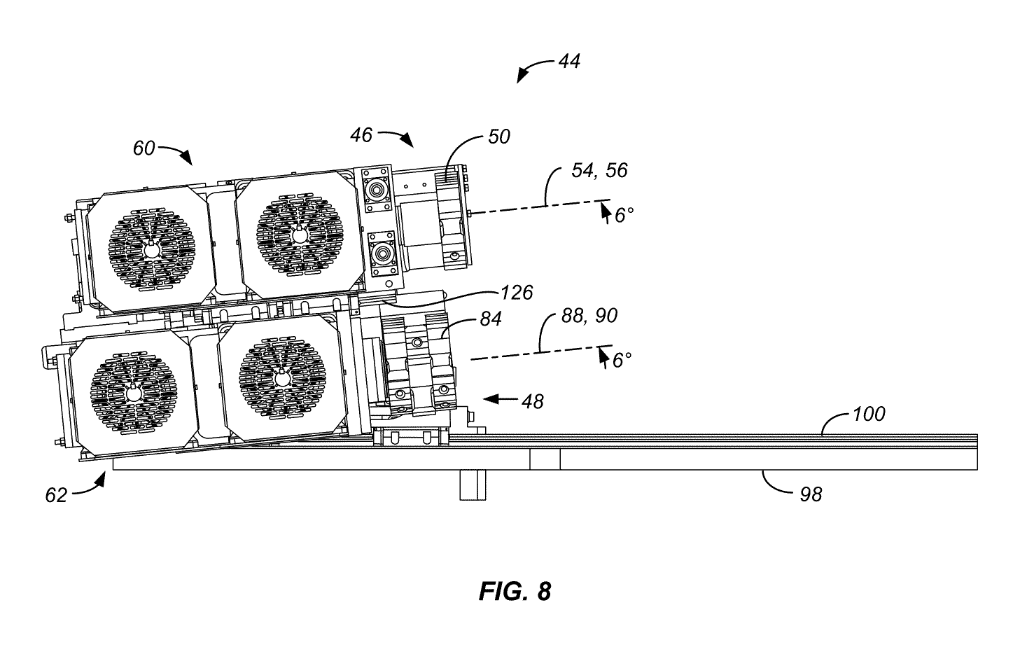

The first and second profiler gearboxes 70, 72 are positioned vertically along splined drive shaft 64 to create appropriately sized and positioned side board profiles 122 in the workpiece. In addition, as illustrated in FIGS. 6 and 7, the relative transverse positions between canter cutter heads 84, 86 and profiler cutter heads 50, 52 can be changed by sliding canter 48 along upper and lower rails 126 connecting profiler 46 and canter 48. Note that only the upper rail 126 is shown in FIGS. 5, 6 and 7. This movement is caused by hydraulic actuator 78, see FIG. 3, and is parallel to axes 54, 56 so that profiler cutter heads 50, 52 and canter cutter heads 84, 86 are properly positioned for engaging the workpiece.

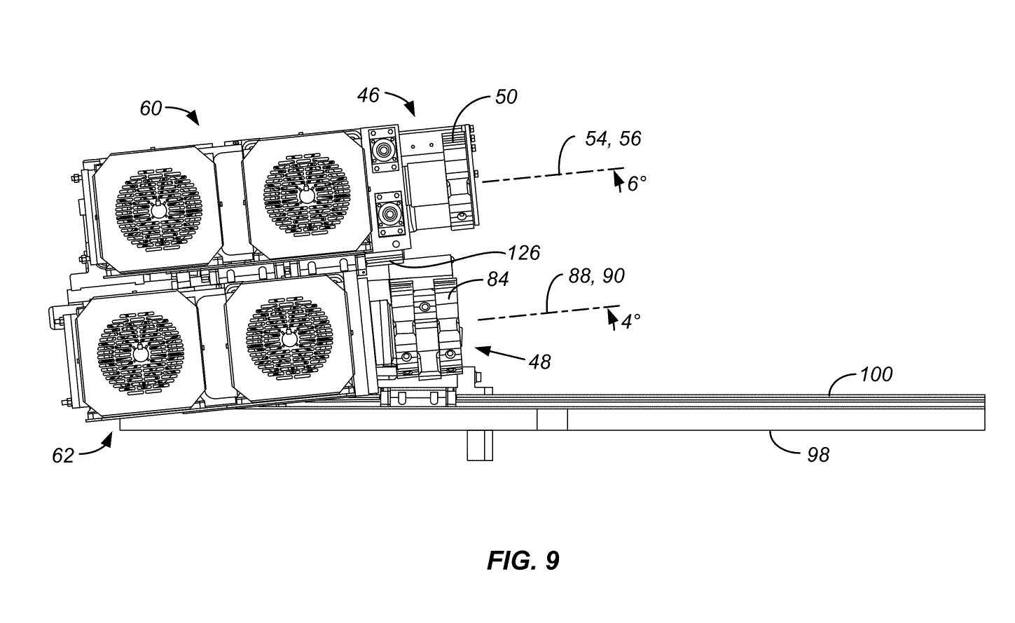

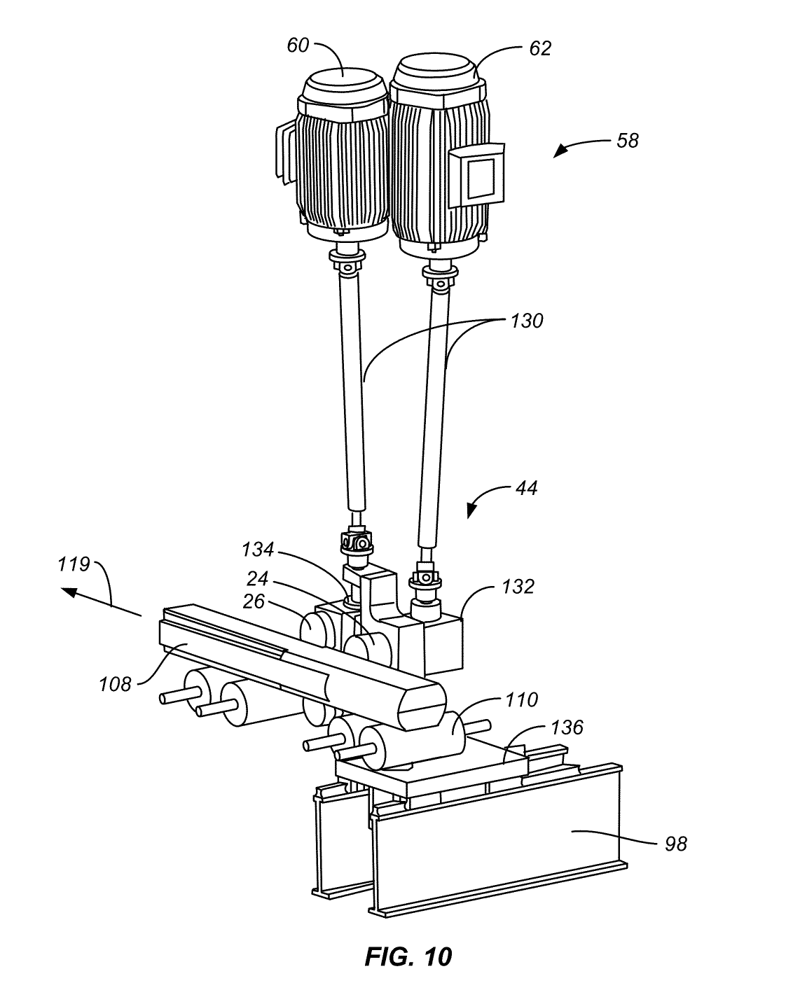

FIG. 8 is a simplified top view of profiler 46 and canter 48 as shown in FIGS. 6 and 7 but after support frame 42 and cutter assembly 44 therewith has been rotated 6° about first axis 118. This rotation about first axis 118 is primarily used to follow the natural curvature of the workpiece so to maximize the amount of processed wood. However, because the canter profiler cutter heads are offset parallel to the workpiece feed path 106, the best offset angle for the canter cutter heads 84, 86 will often not be the same for the profiler cutter heads 50, 52. To accommodate this canter pivot housing 82 can rotate canter gearbox 80 about canter pivot axis 92 so that the angular orientation of first and second profiler cutter heads 50, 52 can be slightly different from the angular orientation of first and second canter cutter heads 84, 86. In the example shown in FIG. 9, profiler cutter heads 50, 52 are offset by a 6° angle while canter cutter heads 84, 86 are offset by a 4° angle. In the present example the maximum offset angle possible by the movement of the main pivot housing 116 is plus or minus 6° while the maximum offset angle possible through the use of canter pivot housing 82 is plus or minus 2°. Other maximum offset angles are possible. In this example canter cutter heads 84, 86 are pivoted relative to profiler cutter heads 50, 52; in other examples profiler cutter heads 50, 52 could be pivoted relative to canter cutter heads 84, 86.

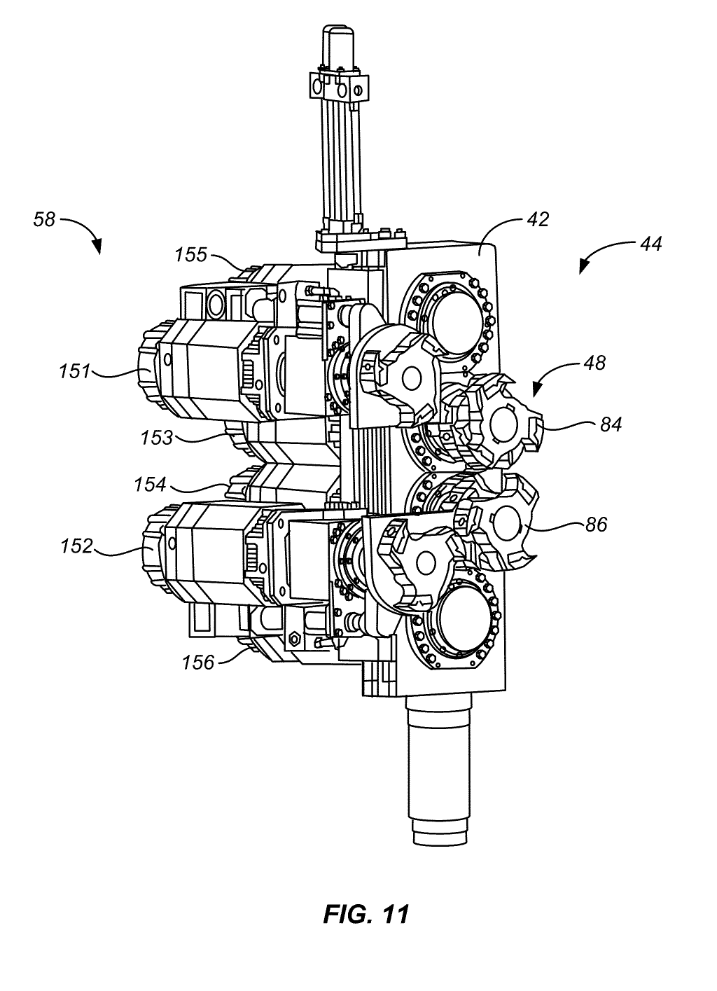

FIG. 10 illustrates another example of a canting and profiling apparatus with like reference numerals referring to like elements. In this example profiler motor assembly 60 and canter motor assembly 62 of motor assembly 58 are positioned above cutter assembly 44. Motor assembly 60 and 62 are connected to profiler 26 and canter 24 by telescoping, constant velocity, Cardan joint or CV joint driveshafts 130 and canter and profiler gearboxes 132, 134. A lateral positioning sliding base 136, which corresponds to lateral slide assembly 104, is used to adjust the lateral position of cutter assembly 44. As with the example of FIGS. 3-9, cutter assembly 44 can be raised and lowered vertically to properly position the cutter assembly with the workpiece.

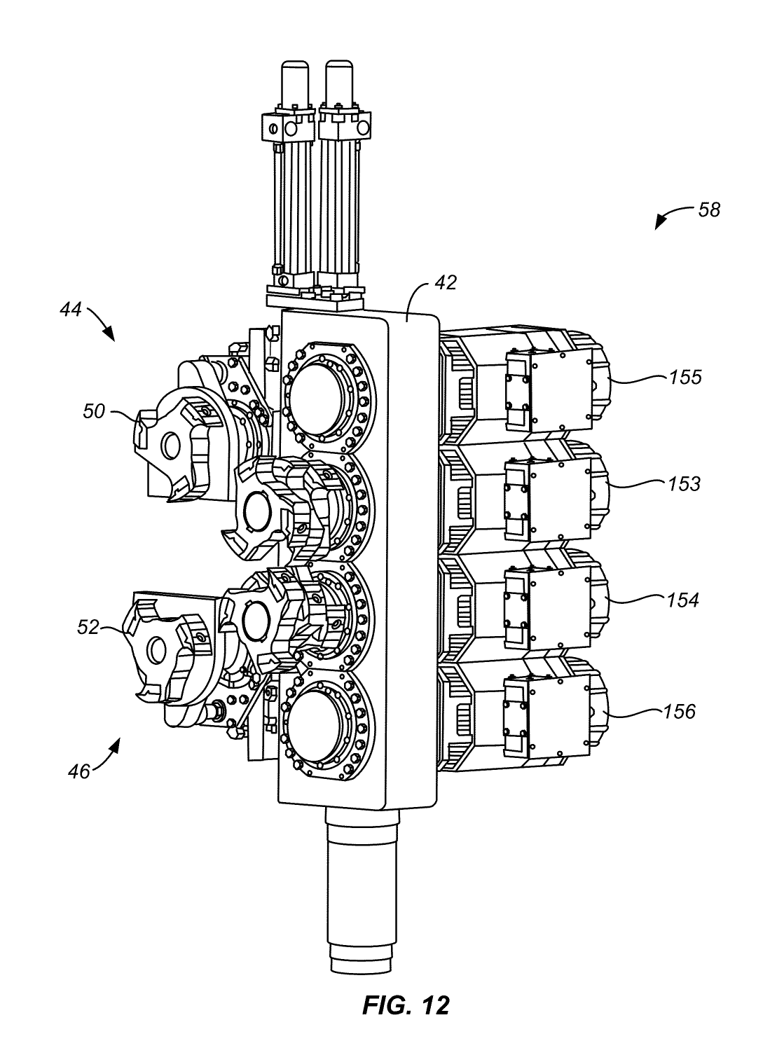

FIGS. 11 and 12 are perspective views of a portion of a further example of a combination canting and profiling apparatus with like reference numerals referring to like elements. Motor assembly 58 includes first, second, third, fourth, fifth and sixth motors 151-156. First and second profiler cutter heads 50, 52 are connected to driveshafts of the first and second motors 151, 152. First and second canter cutter heads 84, 86 are connected to driveshafts of the third and fourth motors 153, 154.

In this example third-six motors 153-156 are drivingly and drivenly coupled to one another for load sharing. Motors 153-156 can be coupled to one another by gears mounted to the respective driveshafts. In this example profiler cutter heads 50, 52 are directly connected to the driveshafts of first and second motors 151, 152 while first and second canter cutter heads 84, 86 are directly connected to the driveshafts of third and fourth motors 153, 154 so that the cutters rotate the same speed as the driveshafts of their respective motors. In other examples the cutter heads need not be directly coupled to and rotated at the same speed as the driveshafts of the respective motors. In still other examples it may be desired to provide load sharing for motors 151, 152 driving first and second profiler cutter heads 50, 52.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

One or more elements of one or more claims can be combined with elements of other claims.

Any and all patents, patent applications and printed publications referred to above are incorporated by reference.

1. A combination canting and profiling apparatus comprising:
a support frame;
a cutter assembly, comprising a profiler and a canter, supported by the support frame for movement in unison with the support frame;
the profiler comprising first and second, spaced apart, profiler cutter heads mounted for rotation about first and second profiler axes and positioned at a workpiece profiling station along a workpiece feed path;
the canter comprising a canter cutter head mounted for rotation about a canter axis and positioned at a workpiece canting station along the workpiece feed path; and
the workpiece profiling station and the workpiece canting station being next to one another.

2. The combination canting and profiling apparatus according to claim 1, wherein the first and second profiler axes are parallel to one another.

3. The combination canting and profiling apparatus according to claim 1, wherein the first and second profiler axes are parallel to the canter axis.

4. The combination canting and profiling apparatus according to claim 1, further comprising:
a base frame;
a carriage supporting the support frame, and the cutter assembly therewith, on the base frame, the carriage comprising:
a lateral slide assembly slideably mounted to the base frame by which a position of the support frame in a lateral direction generally perpendicular to the workpiece feed path can be changed during use; and
a vertical lift assembly movably mounted to the lateral slide assembly by which a vertical position of the support frame can be changed during use; and
a profiler cutter heads mounting assembly mounting the first and second profiler cutter heads to the support frame at different separations so that a distance between the first and second profiler cutter heads can be changed during use.

5. The combination canting and profiling apparatus according to claim 4, wherein the first and second profiler cutter heads are rotatable about first and second profiler axes, the first and second profiler axes being offset from and perpendicular to the workpiece feed path.

6. The combination canting and profiling apparatus according to claim 4, wherein the profiler cutter heads mounting assembly changes the distance between the first and second profiler cutter heads in equal amounts relative to the workpiece feed path.

7. The combination canting and profiling apparatus according to claim 4, wherein:
the carriage further comprises a main pivot housing, mounted to a chosen one of the lateral slide assembly and the vertical lift assembly, rotationally supporting the support frame by which a rotary orientation of the support frame about a first axis can be changed, the first axis being spaced apart from and generally perpendicular to the workpiece feed path; and
the cutter assembly comprising a pivot housing by which a rotary orientation of a chosen one of the profiler and the canter about a second axis can be changed relative to the other of the profiler and the canter, the second axis being parallel to the first axis;
whereby curve sawing is facilitated.

8. The combination canting and profiling apparatus according to claim 7, wherein the profiler and the canter are mounted to the support frame for movement relative to one another along a lateral positioning path oriented generally perpendicular to the workpiece feed path.

9. The combination canting and profiling apparatus according to claim 1, wherein the profiler and the canter are mounted to the support frame for movement relative to one another along a lateral positioning path oriented generally perpendicular to the workpiece feed path.

10. The combination canting and profiling apparatus according to claim 1, wherein the distance between the centers of the profiler and the canter is no more than 24 inches, said centers defined by the profiler axes and the canter axis.

11. The combination canting and profiling apparatus according to claim 1, wherein a region between the profiling station and the canting station is free of any workpiece drivers.

12. The combination canting and profiling apparatus according to claim 1, wherein the canter comprises first and second canter cutter heads mounted for rotation about first and second canter axes.

13. The combination canting and profiling apparatus according to claim 12, wherein the canter cutter heads are counter-rotating canter milling cutter heads.

14. The combination canting and profiling apparatus according to claim 12, further comprising:
a motor assembly comprising driveshafts, and wherein:
the profiler cutter heads and the canter cutter heads are drivenly coupled to driveshafts of the motor assembly.

15. The combination canting and profiling apparatus according to claim 14, wherein the motor assembly comprises a ganged motor assembly comprising at least three motors with driveshafts drivingly and drivenly coupled to one another to provide load sharing among the motors.

16. The combination canting and profiling apparatus according to claim 14, wherein:
the canter comprises first and second canter cutter heads mounted for rotation about first and second canter axes;
the motor assembly comprises first, second, third and fourth motors;
the first and second profiler cutter heads are connected to driveshafts of the first and second motors; and
the first and second canter cutter heads are connected to driveshafts of the third and fourth motors.

17. The combination canting and profiling apparatus according to claim 14, wherein the third and fourth motors are drivingly and drivenly coupled to one another.

18. The combination canting and profiling apparatus according to claim 17, wherein:
the first and second profiler cutter heads are directly connected to the driveshafts of the first and second motors so the first and second profiler cutter heads rotate at the same speed as the driveshafts of the first and second motors; and
the first and second canter cutter heads are directly connected to the driveshafts of the third and fourth motors so the first and second canter cutter heads rotate at the same speed as the driveshafts of the third and fourth motors.

19. The combination canting and profiling apparatus according to claim 17, wherein the ganged motor assembly comprises fifth and sixth motors, the third, fourth, fifth and sixth motors directly coupled to one another by gears mounted to driveshafts of said motors, whereby the driveshafts of the fifth and sixth motors aid the rotation of the driveshafts of the third and fourth motors.

20. A combination canting and profiling apparatus comprising:
a support frame;
a cutter assembly, comprising a profiler and a canter, supported by the support frame for movement in unison with the support frame;
the profiler comprising first and second, spaced apart, profiler cutter heads mounted for rotation about first and second profiler axes and positioned at a workpiece profiling station along a workpiece feed path;
the canter comprising first and second canter cutter heads mounted for rotation about first and second canter axes and positioned at a workpiece canting station along the workpiece feed path;
the workpiece profiling station and the workpiece canting station being next to one another with the distance between the centers of the profiler and the canter being no more than 24 inches, said centers defined by the profiler axes and the canter axes, and a region between the profiling station and the canting station being free of any workpiece drivers;
a base frame;
a carriage supporting the support frame, and the cutter assembly therewith, on the base frame, the carriage comprising:
a lateral slide assembly slideably mounted to the base frame by which a position of the support frame in a lateral direction generally perpendicular to the workpiece feed path can be changed during use; and
a vertical lift assembly movably mounted to the lateral slide assembly by which a vertical position of the support frame can be changed during use;
a profiler cutter heads mounting assembly mounting the first and second profiler cutter heads to the support frame at different separations so that a distance between the first and second profiler cutter heads can be changed during use;
the carriage further comprising a main pivot housing, mounted to a chosen one of the lateral slide assembly and the vertical lift assembly, rotationally supporting the support frame by which a rotary orientation of the support frame about a first axis can be changed, the first axis being spaced apart from and generally perpendicular to the workpiece feed path; and
the cutter assembly comprising a pivot housing by which a rotary orientation of a chosen one of the profiler and the canter about a second axis can be changed relative to the other of the profiler and the canter, the second axis being parallel to the first axis, whereby curve sawing is facilitated.
